(19) United States
(12) Patent Application Publication
(10) Pub. No.: US 2012/0231763 A1
(43) Pub. Date: Sep. 13, 2012

(54) METHOD AND SYSTEM FOR ANTIVIRUS ON A MOBILE DEVICE BY SIM CARD

(75) Inventors: Yang Zeng, Beijing (CN); Yu Lin, Beijing (CN); Shihong Zou, Beijing (CN)

(73) Assignee: BEIJING NETQIN TECHNOLOGY CO., LTD., Beijing (CN)

(21) Appl. No.: 13/414,915

(22) Filed: Mar. 8, 2012

(30) Foreign Application Priority Data
Mar. 9, 2011 (CN) 201110056233.X

(51) Int. Cl. H04W 12/00

(52) U.S. Cl. 455/410

(57) ABSTRACT

The invention provides a method and system for antivirus on a mobile device by a SIM card. The method includes steps of obtaining signature data of a file on the current mobile device, receiving the same, retrieving a virus database on the SIM card for determining whether file on the current mobile device includes a virus and returning the retrieved result to client side of the mobile device, and the client side of the mobile device performing related operation according to the retrieved result.

The invention has advantages that content, stored on a SIM card capable of being transferred with the card avoids the compatibility trouble on content transfer between terminals, and due to control on SIM card by a telecommunication operator, content in a file can be deleted and updated and business can be enabled or disabled from a remote distance under a particular privilege.

### FIELD OF THE INVENTION

The invention relates to a communication security field and, in particular, to a method and system for antivirus on a mobile device by a SIM card.

BACKGROUND OF THE INVENTION

So far, security problem for a mobile device becomes more serious, while the antivirus software for a mobile device must be dependent on operation system of a mobile device, such as Symbian platform developed by Nokia, Andriod platform by Google, IOS platform by Apple and so on. antivirus software for a mobile device must be developed for a specified operation system and therefore eliminates security threat taken by vulnerability on operation system. However, complexity of operation system on a mobile device brings inconvenience and puzzle for a mobile device user to choose and install operation system-related antivirus software system.

The commercial charging mode for antivirus software on a mobile device is mostly dependent on a telecommunication service provider. This means that, upon installing antivirus software on a mobile device, the antivirus software user activates the software by communication between wireless Internet and a server side, and then the telecommunication service provider charges for license fee of the antivirus software from user's personal account. The antivirus provider pays a proportion of service fee to the telecommunication service provider or shares some earnings of the service fee. Commonly, a telecommunication service provider contacts with a personal user with a SIM card, a subscriber identity module card, which stores the user's information, such as a telephone number for identifying a user. Thus, as a unique way to identify a user, SIM card becomes a tie for contacting antivirus software, user and telecommunication service provider, which will not be changed in case that a user applies a new mobile device, and the only step for the user to do is removing SIM card from the original mobile device and installing the same to the new mobile device. However, there has not been a solution for solving the security problem on a mobile device by a SIM card.

When applying a new mobile device, user needs to re-download, install and update antivirus software and virus database. Meanwhile, it is a must for a user to be good at operation system to a mobile device and choose to download information pertained to classification of operation systems. All these processes take time, energy and more technical information skilled by a user.

The prior art cannot provide better security strategy for cross-platform mobile device. In order to solve the above problem, the invention discloses a method for antivirus by an SIM card and gives the telecommunication service provider authority of control on the antivirus or virus database updating by an SIM card.

### SUMMARY OF THE INVENTION

The invention solves a problem by providing a solution for efficiently killing virus on a mobile device by an SIM card.

The invention provides a method for antivirus by an SIM card, comprising steps of obtaining signature data of a file on the current mobile device, receiving the same on the mobile device, retrieving virus database on the SIM card for determining whether the file on the current mobile device comprises a virus, and returning a retrieved result to a client side of the mobile device and performing related operation on the retrieved result by client side of the mobile device.

According to one aspect of the invention, antivirus engine and virus database on the SIM card is structured on the SIM card, and is updated completed by a telecommunication operator.

According to one aspect of the invention, the telecommunication service provider updates the virus database on the SIM card in form of data broadcast with over-the-air technology.

According to one aspect of the invention, the retrieving virus database on the SIM card comprises a step of comparing signature data of the file on the current mobile device with the feature information of the virus file stored on the virus database on the SIM card.

According to one aspect of the invention, the retrieving virus database on the SIM card for determining whether file on the current mobile device comprises an virus is completed by a antivirus engine structured inside the SIM card.

According to one aspect of the invention, the telecommunication service provider updates the antivirus engine on the SIM card in form of data broadcast with over-the-air technology.

According to one aspect of the invention, the retrieving virus database on the SIM card for determining whether the file on the current mobile device comprises a virus is completed by a client side of the mobile device.

According to one aspect of the invention, the method further comprises a step of invoking virus database stored on the client side of the mobile device for a further check upon in case that the retrieved result obtained with virus database on the SIM card is unsure that there is a virus in the file.

According to one aspect of the invention, it provides an antivirus system by an SIM card, comprising an SIM card, a first communication interface and a second communication interface of the SIM card. The SIM card comprises a SIM card virus database, which stores signature data of more virus files and receives update on virus database from the telecommunication operator with the first communication interface. The mobile device on which the SIM card is installed invokes signature data of a virus file stored on virus database on the SIM card with the second communication interface.

### Advantages of the Invention

Content, stored on an SIM card capable of being transferred with the card avoids the compatibility trouble on content transfer between terminals, and deleting or updating content of a file and due to control on SIM card by a telecommunication service provider, content in a file can be deleted and updated and services can be enabled or disabled from a remote side under a particular privilege.

### BRIEF DESCRIPTION OF THE DRAWINGS

A description of the invention will be further given in combination with the flow charts below.

FIG. 1 is a flow chart of operation of a SIM card antivirus engine of the invention;

FIG. 2 is a flow chart of a process of checking and killing a virus by an SIM card virus-killing engine of the invention;

FIG. 3 is a flow chart of the invention with a virus database on a client side of the mobile device;

FIG. 4 is a flow chart of combination of virus databases between client side on mobile device and SIM card of the invention;

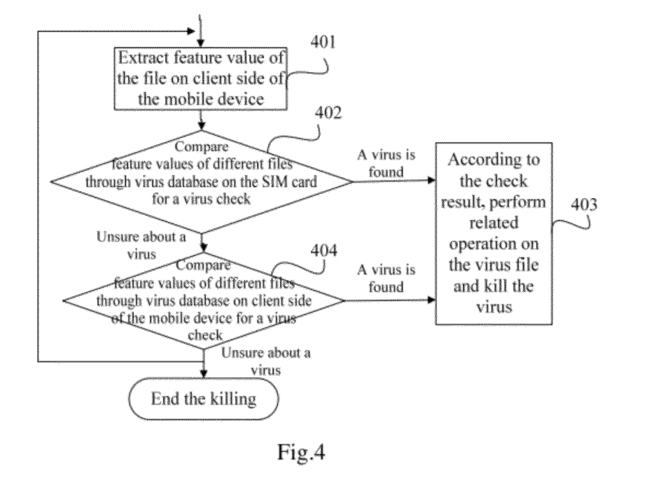

FIG. 5 is a system schematic of antivirus by an SIM card of the invention.

### DETAILED DESCRIPTION OF THE INVENTION

The invention provides a method for checking, killing and controlling a virus by an SIM card. Mobile telecommunication service provider updates virus database on an SIM card through the SIM card, provides client side of a mobile device with a Read privilege, makes mutual communication with client side of the mobile device by the SIM card and therefore checks, kills and controls virus on the mobile device.

According to one embodiment of the invention, a method for killing virus based on SIM card is provided, which installs virus database on an SIM card and a related client side on a mobile device, and checks and kills virus by interaction between a client side and an SIM card. The client side on a mobile device communicates with the SIM card and sends message digest of a file, such as the signature, on the current mobile device to the antivirus engine, and the antivirus engine receives the program and file message digest on the current mobile device returned by client side on the mobile device and determines whether the received is a virus or not with virus database on the SIM card and returns a virus-killing result, and the client side on the mobile device performs a related operation on the result returned by the SIM card, which includes, but not limit to, isolating or deleting the virus and sending a prompt to the user.

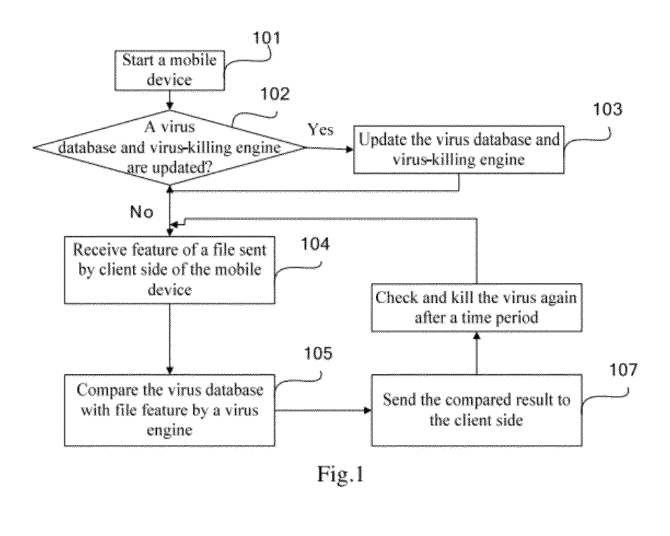

According to one embodiment of the invention, the process of checking a virus by an SIM card virus database is illustrated as FIG. 1. First at step 101, a user starts a mobile device when an SIM card has been installed into a related insert slot of the mobile device. At step 102, the user checks whether it is necessary for updating virus database and antivirus engine, which includes steps of visiting server side of a telecommunication operator with over-the-air technology or other wireless communication technology, such as WCDMA, TD-SCDM A or CDMA2000, and enables the telecommunication service provider to update the current virus database at request and therefore ensures to check and kill virus exactly and timely.

If an update is checked at step 102, step 103 is executed, and a latest virus database is downloaded by connecting to a server related to the telecommunication operator, and the virus database on the current SIM card is updated, and Step 104 is executed.

If an update is not checked at step 102, step 104 is executed, and a process of checking and killing virus is started by the antivirus engine. Firstly, a request is sent by the SIM card to client side on the upper-layer mobile device, which represents that the virus database on the SIM card is ready and information of the current program and files are requested.

After a response, the client side on the mobile device returns information of current file and program having been installed, and the antivirus engine receives the same sent by the client side on the mobile device. At step 105, the antivirus engine checks virus according to information of the current virus database and file and program having been installed, and at step 106, returns the checked result to the client side on the mobile device. Then the client side on the mobile device performs the antivirus operation according to the checked result.

After a time period, the client side on the mobile device sends a request to the antivirus engine, and the antivirus engine repeats the above virus-killing steps. Herein the time period is set by performance of CPU of the SIM card and of the mobile device, or by a mobile device user for killing virus, and the client side on the mobile device will automatically check and kill virus according to the time period.

According to the embodiment, the applied mobile device includes a mobile phone, netbook, and PDA or electronic book capable of surfing Internet. The SIM card, a subscriber identity module card, is also named a smart card, a user ID identifying card, which is a necessity for a digital mobile phone or networking mobile notebook. SIM card is a smart card with a micro-processor, is consisted of a CPU, program memory RAM(Read-Only-Memory), working memory RAM(Random Access Memory), data memory unit EPROM(Erasable Programmable ROM) or E2PROM(Electrically Erasable Programmable ROM) and serial communication unit. With storage capability, SIM card can store information of a digital mobile user, encrypted key and telephone book of a user, can also be used for identifying identity of a mobile communication user identity and for encrypting voice message of a user during a phone talk. The SIM card in the embodiment applies a data storage unit of 8K, 16K, 32K, 64K or 16K,512 k, 1 g,4 g or more.

The updating antivirus engine and virus database is completed by the operator assisted by anti-virus manufacturer herein.

According to the embodiment, the telecommunication operator applies OTA (Over-the-Air) technology to manage data and applications on an SIM card from a remote distance by air interface of the mobile communication technology, such as GSM or CDMA. The air interface can apply WAP, GPRS, CDMA1X and short-message technology. With OTA technology, telecommunication operator is capable of providing voice and data service, and new-service downloading, whereby it updates antivirus engine and virus database.

According to the embodiment, virus database on the SIM card is stored in the data memory unit of the SIM card, such as EPROM or EPPROM. EPROM, Erasable Programmable ROM, is a chip capable of being erased and written into repeatedly. EPPROM, Electrically Erasable Programmable Read-Only Memory, a non-volatile storage chip upon power off.

Virus database on an SIM card includes a virus information list, which is commonly provided by a antivirus software provider. The virus information includes at least of three types of information, virus type, virus name and virus signature code. Virus type subject to a mobile device includes malicious payment, privacy stealing and trojan etc. Virus name is a name generally defined for a virus by a antivirus software company or other organization, such as geimimi.A. Virus signature code is a code computed by a antivirus software company for a particular virus file, which in details is a message digest generated by binary codes of one virus file. The computing the virus feature code applies secure hash algorithm of SHA-1 version or MD5 version, or others. Whichever algorithm is selected, it is necessary for the computing step that each virus file corresponds to one unique message digest, which is convenient for identifying and extracting a virus file.

According to the embodiment, the communication between the mobile device and the SIM card complies with a protocol of ISO7816-4 specification. The protocol is a word-oriented protocol, which means that a word is a minimum data unit of the transfer between the SIM card and the mobile device. A word may include an application protocol data unit(APDU) for defining a particular application. With the protocol of ISO7816-4 specification, the mobile device sends a particular APDU instruction to the SIM card with a special application program interface (API), returns a response of the SIM card, and therefore completes invoking resource and function of the SIM card by client side of the mobile device.

The antivirus engine receives information of a program and file on the current mobile device returned by the client side on the mobile device, determines whether there is a virus according to the virus database and returns a determined result.

According to one embodiment of the invention, the antivirus engine is an antivirus engine on the SIM card, which is structured on the SIM card and invokes central processing unit and working memory RAM of the SIM card to perform virus-checking related operation.

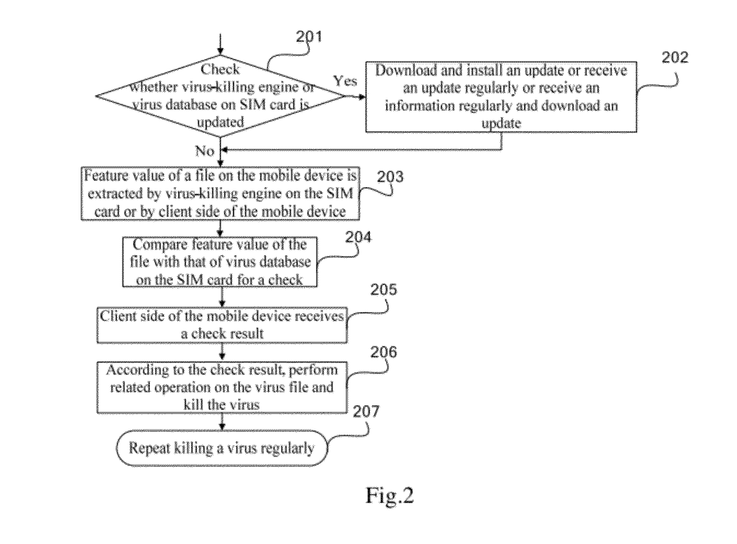

According to the embodiment, FIG. 2 is a flow chart of a response by antivirus engine of the SIM card to client side on the mobile device.

First at step 201, the client side on the mobile device determines whether the antivirus engine on the SIM card is ready. Specifically, the antivirus engine is structured inside the SIM card. The communication between the SIM card and the telecommunication service provider applies OTA (over-the-air) technology, and is complied with SMS_PP transfer mode described in GSM03.48 protocol. According to purpose and solution of the invention, a person skilled in the art should know that other forms of OTA technology, such as multi-media message or WAP telecommunication transfer mode, is also applicable.

In details, the version information of antivirus engine and virus database on the current SIM card is sent to the telecommunication operator by the over-the-air technology in form of upstream communication. Information of user and version is presented in form of datagram. Processor on the SIM card or the mobile device encodes the datagram, divides the datagram into segments, generates relating MAC code and random bit, generates one or more short messages by the segments according to a short message form and byte-length limitation defined by the telecommunication service provider, and encodes the synchronized serial number of the short message.

The generated short message is sent to a base station of the telecommunication service provider by the mobile device, and is forwarded to other telecommunication server side.

At step 202, the telecommunication server side checks the version information, if it is necessary to update the antivirus engine or virus database on the SIM card, it sends the update-related data to the mobile device by OTA technology in form of downstream communication. The communication complies with SMS_PP transfer mode described in GSM03.48. Data for update is downloaded into the SIM card in form of a short message. If more than one short message is included, processor of the SIM card sorts them, generates datagram, and antivirus engine or virus database on the SIM card with the decoded data by lower level operation on the SIM card.

Preferably, the telecommunication operator informs user of the mobile device of update on antivirus engine or virus database on the SIM card in form of data broadcast via OTA technology, and prompts the user of downloading the update data package. The way to download the data package is not limited to OTA, but other way such as WAP or CDMA1x.

Preferably, the telecommunication operator sends update on antivirus engine or virus database on the SIM card to users in form of data broadcasting as request or regularly, or sends a prompt of downloading the data package to users in form of data broadcast and they completes the downloading.

When the antivirus engine on the SIM card is ready, the client side of the mobile device obtains information and the signature of a file on the mobile device as shown at step 203. According to the embodiment, the client side of the mobile device scans a file on the mobile device, and extracts related the signature, which includes a step of computing a message digest from each scanned file on the mobile device. The computing step may apply secure hash algorithm such as SHA-1 or MD5. By the computing step, file on each mobile device relates to one unique message.

Alternatively, the obtaining information and the signature of a file on the mobile device may be completed by antivirus engine on the SIM card. In details, the above step includes that client side of the mobile device transfers the file to be checked with virus to the SIM card with ISO7816-4 specification protocol and the signature is extracted by antivirus engine on the SIM card.

At step 204, antivirus engine on the SIM card compares the extracted the signature of the file with the signature of virus file stored on the virus database on the SIM card for a check and returns the check result to the client side on the mobile device. At step 205, the client side on the mobile device receives the check result from the antivirus engine on the SIM card. At step 206, the client side on the mobile device performs pertained operation according to the check result, for checking and killing a virus, which includes that deleting a virus file, killing a process of the virus file or renaming and isolating virus file etc. At the following step 207, a time period is set for repeating the above steps, which is set on the client side on the mobile device.

Alternatively, the step of updating the virus database and antivirus engine includes steps of checking whether there is an update on the virus database and the antivirus engine when computer is started, if there is, performing the update by coupling to a server of the telecommunication operator. The connecting step applies OTA technology. By an air interface, the update on virus database and the antivirus engine may be downloaded onto the SIM card from server side on the telecommunication operator with WAP, GPRS, CEMA1X and short message technology. Moreover, the virus database and the antivirus engine on the SIM card may be updated by control of client software on the mobile phone.

The client side on the mobile device communicates with antivirus engine on the SIM card, sends information of software installed on the current mobile device to the antivirus engine on the SIM card for checking and killing a virus, and performs related operation according to the result responded by the SIM card. The client side on the mobile device communicates with antivirus engine on the SIM card regularly or irregularly. For example, a user may set a regular time, frequency or trigger event for checking and killing a virus for antivirus engine on the SIM card by client side on the mobile device.

According to one embodiment of the invention, the virus database on the SIM card is classified by different operation system of client side on different mobile device, such as Symbian operation system developed by Nokia, Android operation system by Google and IOS operation system by Apple. The retrieving the virus database on the SIM card is limited to classification related to a particular operation system. Prior to step 204, the antivirus engine on the SIM card receives related information from the operation system on the mobile device before retrieving the signature of the file. And at step 204, the retrieving scope of the antivirus engine on the SIM card is limited to the classification of the virus related to the operation system.

According to one embodiment of the invention, the virus-checking for starting the virus-killing step by antivirus engine on the SIM card is launched after startup of the mobile device.

According to another embodiment of the invention, the virus-checking for starting the virus-killing step by antivirus engine on the SIM card is launched by invoking the antivirus software installed on the mobile device. The invoking the antivirus software can be realized by the regular virus-killing feature set by the antivirus software or launched by installing or inputting a new file to the mobile device. A person skilled in the prior art should know that other ways to start a antivirus software are also applicable in the invention.

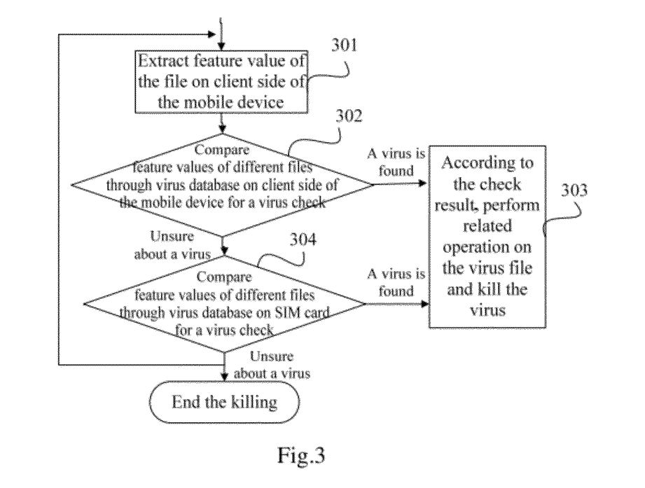

According to one embodiment of the invention, the antivirus software installed on the mobile device starts the virus-killing step as a response to operation by a user of the mobile device. As shown in FIG. 3 at step 301, the signature, of a file of the mobile device is extracted by antivirus software on the mobile device, which includes a message digest of the file by computing with secure hash algorithm such as SHA-1 and MD5. By the computing step, file on each mobile device relates to one unique message. At step 302, the antivirus software on the mobile device compares the extracted the signature of the file with feature value of virus file stored on the virus database on the mobile device.

If the compared result confirms a virus in the file, step 303 is executed and the antivirus software on the mobile device performs further operation on the virus file, such as deletion and isolated. Or if the compared result is unsure that there is a virus in the file, step 304 is executed, and the signature of the file is sent to the antivirus engine on the SIM card and the antivirus engine on the SIM card obtains the signature of virus in the virus database on the SIM card and compares the same with the signature of the file. If the compared result confirms a virus in the file, step 303 is executed and the antivirus software on the mobile device performs further operation on the virus file, such as deletion and isolated. If the compared result is still unsure that there is a virus in the file, step 301 is executed to extract the signature of the next file of the mobile device, or the virus-killing process is ended.

According to one embodiment of the invention, the client side on the mobile device obtains information and the signature of a file on the current mobile device, as shown at step 401, scans file on the current mobile device and extracts the signature thereof.

The step of extracting the signature includes a step of computing a message digest for file on each scanned mobile device with secure hash algorithm such as SHA-1 or MD5. By the computing step, a file in each mobile device relates to one unique message.

And at step 402, the message digest or the signature thereof is returned to antivirus engine on the SIM card, and it compares the extracted the signature of the file with the signature of the virus file stored on the virus database on the SIM card for checking, and returns a check result to client side on the mobile device.

If the check result confirms a virus in the file, step 403 is executed and the antivirus software on the mobile device performs further operation on the virus file, such as deletion or isolated. Or if the check result is unsure that there is a virus in the file, step 404 is executed, and the signature of the file is checked by virus database of the antivirus software on the mobile device. If the check result confirms a virus in the file, step 403 is executed and the antivirus software on the mobile device performs further operation on the virus file, such as deletion or isolated. If the check result is still unsure that there is a virus in the file, step 401 is executed to extract the signature of the next file of the mobile device, or the virus-killing process is ended.

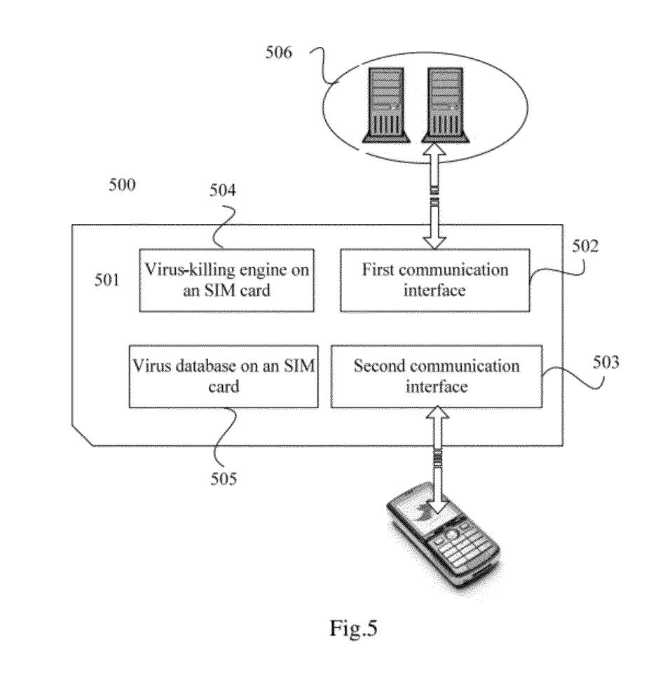

According to one embodiment of the invention, a system for checking and killing a virus by an SIM card is provided. As shown in FIG. 5, the system 500 for checking and killing a virus includes an SIM card 501, a first communication interface 502 and a second communication interface 503 of the SIM card, a antivirus engine 504 and virus database 505 on the SIM card. The first communication interface 502 of the SIM card is applied to communicate with telecommunication server side 506, and to update and download the antivirus engine 504 and virus database 505 of the SIM card onto the SIM card 501. According to the embodiment, the first communication interface 502 applies OTA technology and data and applications on the SIM card are managed from a remote distance by air interface with mobile communication technology, such as GSM and CDMA. The second communication interface 503 is used for communication between SIM card 501 and client side 507 of the mobile device. According to the embodiment, the second communication interface 503 applies ISO7816-4 specification protocol.

Virus database 505 on the SIM card stores signature data of more virus files. According to the embodiment, virus database on the SIM card includes a list of virus information which is generally provided by a antivirus software provider. The virus information includes at least three types of information, virus type, virus name and feature code of a virus. The virus type related to the mobile device includes malicious payment, privacy-stealing and projan. The virus name is commonly a name defined for a virus by a antivirus software company or other organization, such as geimimi.A. The virus feature code is computed by a antivirus software company for a particular virus file, which is a message digest generated by binary codes of each virus file with secure hash algorithm, such as SHA-1 and MD5.

When the client side 507 on the mobile device on which the SIM card is installed, sends file signature data to SIM card 501 by the second communication interface 503, the antivirus engine 504 on the SIM card receives the file signature data and retrieves the same with the signature data of the virus file stored on the virus database 505 on the SIM card. The antivirus engine 504 on the SIM card compares the received file the signature with the signature of the virus file stored on the virus database 505 on the SIM card for a check, and returns a check result to the client side 507 on the mobile device with the second communication interface 503.

According to one embodiment of the invention, what a antivirus engine on the SIM card executes may be completed by the client side 507 on the mobile device. The client side on the mobile device includes a antivirus engine on the client side. The antivirus engine on the client side receives the file signature data, retrieves the same via the feature information of the virus file stored on the virus database 505 on the SIM card, and compares the received file feature information with the feature information of the virus file stored on the virus database 505 on the SIM card for a check.

According to one embodiment of the invention, the antivirus engine 504 on the SIM card extracts the file signature data on the mobile device. In details, the client side 507 on the mobile device sends the file for virus-checking to the SIM card, and the antivirus engine 504 on the SIM card applies secure hash algorithm such as SHA-1 and MD5, for computing the signature of the file and compares the computed the signature with the signature of the virus file stored on the virus database 505 of the SIM card for a check.

For description of purpose of the invention, not all combination of methods and devices are exhausted herein, but a person skilled in the art should know that more combination and modification are included in the invention. Therefore, the invention includes all modification, changes and substitution, for example methods for updating the antivirus engine and virus database on an SIM card, content of communication between an SIM card and client side of the mobile device, and processes executed by client side of the mobile device. Moreover, although a particular feature of the invention may be disclosed by one embodiment of the invention, it also may be combined with other features in other embodiment of the invention.

We claim:

1. A method for antivirus by a SIM card, wherein it comprises steps of
obtaining signature data of a file on a current mobile device;
receiving the same on the mobile device;
retrieving a virus database on the SIM card for determining whether file on the current mobile device includes a virus;
returning a retrieved result to a client side of the mobile device; and
performing related operation according to the retrieved result by client side of the mobile device.

2. The method for antivirus by a SIM card of claim 1, further comprises that the virus database on the SIM card is structured on the SIM card and is updated completed by a telecommunication operator.

3. The method for antivirus by a SIM card of claim 2, wherein the telecommunication operator updates the virus database on the SIM card in form of data broadcast with over-the-air technology.

4. The method for antivirus by a SIM card of claim 1, wherein the retrieving virus database on the SIM card comprises a step of comparing signature data of the file on the current mobile device with the feature information of the virus file stored on the virus database on the SIM card.

5. The method for antivirus by a SIM card of claim 1, wherein the retrieving virus database on the SIM card for determining whether file on the current mobile device comprises a virus is completed by a antivirus engine structured inside the SIM card.

6. The method for antivirus by a SIM card of claim 5, wherein the telecommunication operator updates the antivirus engine on the SIM card in form of data broadcast with over-the-air technology.

7. The method for antivirus by a SIM card of claim 1, wherein the retrieving virus database on the SIM card for determining whether the file on the current mobile device comprises a virus is completed by a client side of the mobile device.

8. The method for antivirus by a SIM card of claim 1, further comprises a step of invoking virus database stored on the client side of the mobile device for a further check in case that the retrieved result obtained with virus database on the SIM card is unsure that there is a virus in the file.

9. A system for antivirus by a SIM card, comprises a SIM card, a first communication interface and a second communication interface of the SIM card, wherein the SIM card further comprises an SIM card virus database which stores signature data of more virus files;
the virus database on the SIM card receives update on virus database from the telecommunication operator with the first communication interface; and
the mobile device on which the SIM card is installed invokes signature of a virus file stored on virus database on the SIM card with the second communication interface.
